(19) United States
(12) Patent Application Publication
(10) Pub. No.: US 2003/0192063 A1
(43) Pub. Date: Oct. 9, 2003

(54) Digital interface unit apparatus and system

(75) Inventor: Frederick S. Runkle, Buford, GA (US)

Correspondence Address: HINKLE & O'BRADOVICH, LLC, 395 SCENIC HIGHWAY, LAWERENCEVILLE, GA, 30045, US

(73) Assignee: Cable Innovations, Inc.

(21) Appl. No.: 10/118,826

(22) Filed: Apr. 9, 2002

(51) Int. Cl. H04N 7/173; H04N 7/16

(52) U.S. Cl. 725/149; 725/127

(57) ABSTRACT

A digital interface apparatus and system for cable television systems and digital service are disclosed. The apparatus includes a housing with an input and two outputs. The housing includes a surge protection circuit connected to the input and to a signal dividing circuit that is connected to an output and a filtering circuit that is connected to another output.

### BACKGROUND

I. Field of the Invention.

The present invention relates generally to the field of digital service in cable television systems, and more particularly to a digital interface apparatus and system.

II. Description of the Related Art.

Cable television digital interface units typically include a ground block in tandem with a splitter or directional coupler followed by a high pass filter or a window filter. Signal splitting and filtering is important because the digital data signals that come in with the drop cable and intended for a modem can often interfere with television signals causing problems such as “sparkles” on the television. Each of the above-mentioned units are separate and often have to be individually mounted on the subscribers residence. These units typically do not include any surge protection device. Several problems typically arise from having a collection of units. Having many different units connected by cables results in increased radio frequency (RF) leakage due to a high number of connectors that is a typical source of RF leakage, difficulty in installation and maintenance, increased exposure to environmental elements, lack of mechanical and electrical integrity and compatibility, increased susceptibility to corrosion, as well as aesthetic problems with subscribers. Typically, many of these individual units are collected into a plastic housing for weather protection and to gather of the units into a single location. However, these housings do not reduce any of the above mentioned problems.

### SUMMARY OF THE INVENTION

In general, the invention features a digital interface unit apparatus and system for cable television systems. The apparatus can typically include improved filters, splitters and couplers as well as a surge protector.

In general, in one aspect, the invention features a digital interface unit apparatus, including an input connected to a surge protection circuit, a first output connected to a signal dividing circuit connected to the surge protection circuit and a second output connected to a filter circuit connected to the signal dividing circuit, wherein the surge protection, the signal dividing and the filter circuits are located within a single housing.

In one implementation, the signal dividing circuit is a two-way splitter

In another implementation, the signal dividing circuit is a 6 dB directional coupler.

In another implementation, the signal dividing circuit is a 9 dB directional coupler.

In another implementation, the filter circuit is a high pass filter.

In another implementation, the filter circuit is a window filter.

In another implementation, the filter circuit is a 5-13 MHz window filter.

In another implementation, the filter circuit is a 8-10 MHz window filter.

In another implementation, the apparatus includes a grounding device connected to the housing.

In still another implementation, the grounding device comprises a ground wire connection and a ground screw, both adapted to receive and connect a ground wire to the apparatus.

In yet another implementation, the apparatus includes voltage blocking capacitors electrically coupled to each of the input and the outputs.

In another implementation, the housing includes surface mounting tabs.

In another implementation, the input and the outputs are integral with the housing.

In another aspect, the invention features a self-contained cable television and digital signal interface apparatus, including a housing having three ports, means for receiving a cable signal coupled to one of the ports, means for dividing the signal located within the housing, means for routing part of the divided signal to one of the ports, means for routing another part of the signal to one of the ports.

In one implementation, the means for dividing the signal is a splitter.

In another implementation, the means for dividing the signal is a directional coupler.

In another implementation, the apparatus includes means for filtering a part of the cable signal coupled to the means for dividing the signal and to one of the ports.

In another implementation, the cable signal comprises a television signal and a data signal.

In another aspect, the invention features a digital interface unit system, including a digital interface unit apparatus, including an input connected to a surge protection circuit, a first output connected to a signal dividing circuit connected to the surge protection circuit and a second output connected to a filter circuit connected to the signal dividing circuit, wherein the apparatus is contained within a housing, a ground connection connected to the housing, a ground rod connected to ground and to the ground connection and a cable connected to each of the input and the outputs.

In one implementation, the system includes a cable modem connected to the first output.

In another implementation, the system includes a television system connected to the second output.

One advantage of the invention is that small number of connectors on the housing as well as a sealed housing results in less RF leakage.

Another advantage is the connectors are flattened and smoothed thereby creating a better seal with the o-ring typically located in the connector on the coaxial cables. The apparatus connectors are also located on the bottom of the housing thereby further protected from rain from above. These features result in decreased corrosion.

Another advantage is that the mounting tabs are reinforced and the connectors are an integral part of the housing thereby increasing the overall mechanical integrity of the apparatus.

Still another advantage is that installation and maintenance time is decreased due to the fewer number of connections and cables needed fore the self-contained apparatus.

Another advantage is that several circuit units are self-contained within a single housing thereby increasing the aesthetic appearance of a subscribers residence.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates an embodiment of a digital interface unit apparatus;

FIG. 2 illustrates a block diagram view of an embodiment of a digital interface unit apparatus;

FIG. 3 illustrates a block diagram view of an alternate embodiment of a digital interface unit apparatus;

FIG. 4 illustrates an embodiment of a digital interface system;

FIG. 5 illustrates a schematic diagram of an embodiment of a digital interface unit;

FIG. 6 illustrates a schematic diagram of another embodiment of a digital interface unit;

FIG. 7 illustrates a schematic diagram of another embodiment of a digital interface unit;

FIG. 8 illustrates a schematic diagram of another embodiment of a digital interface unit;

FIG. 9 illustrates a schematic diagram of another embodiment of a digital interface unit;

FIG. 10 illustrates a schematic diagram of another embodiment of a digital interface unit;

FIG. 11 illustrates a schematic diagram of another embodiment of a digital interface unit;

FIG. 12 illustrates a schematic diagram of another embodiment of a digital interface unit;

FIG. 13 illustrates a schematic diagram of another embodiment of a digital interface unit;

FIG. 14 illustrates a schematic diagram of another embodiment of a digital interface unit;

FIG. 15 illustrates a schematic diagram of another embodiment of a digital interface unit; and

FIG. 16 illustrates a schematic diagram of another embodiment of a digital interface unit.

### DETAILED DESCRIPTION OF THE INVENTION

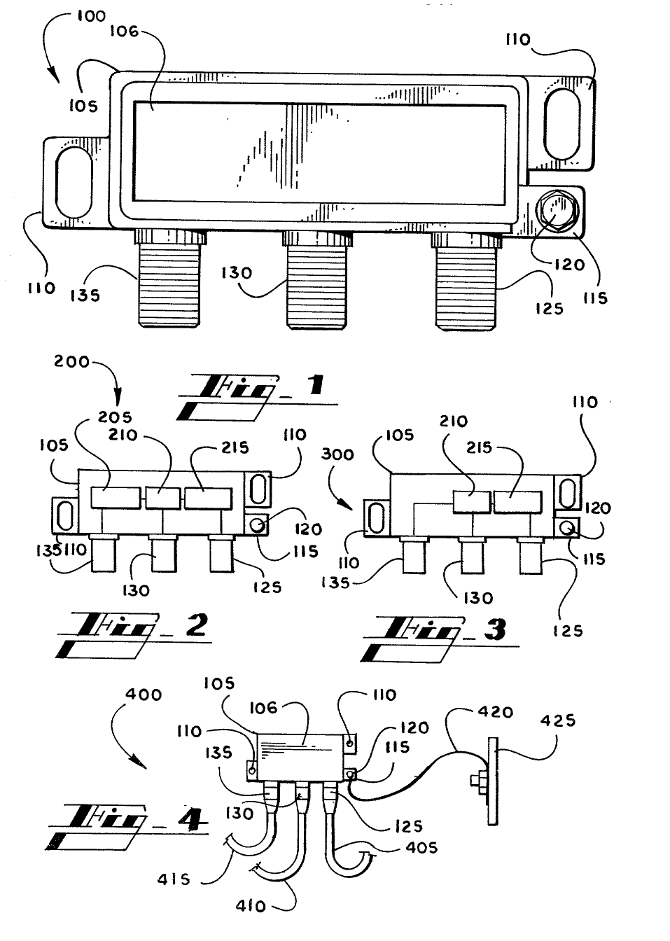

Referring to the drawings wherein like reference numerals designate corresponding parts throughout the several figures, reference is made first to FIG. 1 that illustrates an embodiment of a digital interface unit apparatus 100. The apparatus 100 typically includes a housing 100. In an embodiment, the housing is typically a metallic substance that is resistant to corrosion such as chromate zinc. A housing lid 106 covers an opening of the housing 105 that exposes the internal circuitry of the apparatus 100. In one embodiment, the lid 106 is typically a metallic substance that is weather resistant such as brass with tin plating. The apparatus 100 also typically includes mounting tabs 110 that are adapted to be aligned with a surface such as the exterior of a house. The tabs 110 can be attached to the surface with suitable implements such as screws, nails and the like. The apparatus 100 also typically includes a grounding device 115. The grounding device is electrically coupled to the internal circuitry that is described in more detail below. The grounding device 115 typically includes a screw 120 that can be used to attach the grounding device 115 to a grounding wire (not shown) that is coupled to a grounding rod or other suitable grounding device, such as a power service grounding electrode system.

The apparatus 100 also typically includes an input port 125. The input port 125 is typically adapted to receive a cable line of the coaxial type. The input signal is typically a cable signal carrying both a television signal and a data signal adapted to be received by a cable modem. The apparatus can also include two output ports 130, 135. One output port 130 typically carries the portion of the input cable signal containing the cable modem data. The other output 135 typically carries the portion of the cable signal having the television signal. In another embodiment, both outputs 130, 135 can carry the data signal. In another embodiment, both outputs 130, 135 can carry the television signal. The ports 125, 130, 135 typically include a gold plate 360-degree center pin socket that helps to insure good contact and proper impedance matching with respective coaxial cables. In an embodiment, a ferrite material is located between the output port 130 and the output port 135 to minimize over driving of the input of a connected television during the transmission of a connected digital cable modem high level upstream signaling. This material provides isolation between the two ports 130, 135.

In an embodiment, the lid 106 and the input 125 and outputs 130, 135 are soldered to the housing or are integral parts of the housing. This soldering and integration helps to reduce RF leakage. Further RF leakage is attained by having a reduced number or input and output ports on the apparatus 100.

FIG. 2 illustrates a block diagram view of an embodiment of a digital interface unit apparatus 200. The apparatus 100 is shown with the lid 106 removed from the housing 105. FIG. 2 illustrates three functional blocks 205,210,215 that represent the internal circuitry of the apparatus 200. It is understood that the blocks 205, 210, 215 are shown for illustrative purposes. Typically the input port 125 of the apparatus is first connected to a surge protection circuit 215. If there are any unwanted surges or other transients on the cable input signal, the surge protection circuitry can typically trigger a rapid clamping action to dissipate the harmful effects of the surge. In one embodiment, the surge protection circuit 215 is a circuit such as the circuit disclosed in U.S. Pat. No. 5,216,569. In general the surge protection circuit 215 includes an inductor in series with a sidactor connected to ground and a coupling capacitor feeding the dividing circuit 210. A tract between the input port 125 and the inductor in the circuit is designed as a fusable link. The inductor is typically made of four turns of wire through a ferrite bead. The inductor functions to keep the high frequency signals from being sent to ground through the sidactor and to provide a path for surge voltage, which is typically a very low frequency during the conduction of the sidactor. The sidactor is a crowbar device that protects circuits from transient voltage. In a standby mode, the sidactor has a high off-state resistance, much like a capacitor. Upon the application of a voltage exceeding the breakover voltage, the device switches to essentially a short. When the over voltage is removed, the sidactor returns to an off state. This action protects the apparatus 100 plus devices connected to the apparatus 100 by the subscriber. The coupling capacitor functions to keep currents from flowing through connected transformers in the signal dividing circuit 210 to prevent ferrite core saturation of the transformer and hum on the video signal and to break the low impedance circuit through the transformer to ground, so that the surge circuit 215 functions properly.

A signal dividing circuit 210 is typically coupled to the surge protection circuit 215 and to the output port 130. The cable television system is typically the determining factor in the choice of dividing circuit used. In a typical embodiment, the dividing circuit is either a two-way splitter circuit or a directional coupler circuit. If a splitter circuit is used, the cable signal is divided equally. If a directional coupler is used, the cable modem data signal sent to the output port 130 is attenuated as required by some cable modem. In typical embodiments, the directional coupler is either 6 dB or 9 dB. It is understood that other couplers are contemplated as necessary in the cable system. It is also understood that other signal dividing circuits are also contemplated.

A filter circuit 205 is typically coupled to the signal dividing circuit 210 and to the output port 135. The choice of filter circuit is numerous depending on the cable television system and the requirements of the system. Some typical embodiments of filter circuits that can be used are high pass filters, window filters and no filters. In many cable television systems, a high pass filter passing a band of 54 MHz to 1000 MHz is typical. In such an embodiment, signals between 5 MHz and 40 MHz is attenuated greatly (typically about 40 dB). This attenuation helps to keep noise out of the return path of the system. The signals above 54 MHz pass with very little attenuation. In other embodiments, the components of the circuit can be adjusted to change the range of pass and attenuation as needed by the system requirements.

Window filters can also be implemented as the filter circuit 205. A window filter is a combination of a band pass section and a high pass section. Often times the subscribers converter box uses the lower end frequency section of the signal for communication, and the higher end frequency section is used to transmit the television signal. However, the section of the signal between the two can contain noise and data signals that can cause interference in the television signal. These interferences often show up as “sparkles” on the subscribers television. The window filter can filter out these unwanted signals and noise. Two typical band pass (or window) frequencies are 5-13 MHz and 8-10 MHz. It is understood that these frequencies can be modified to meet specific system requirements.

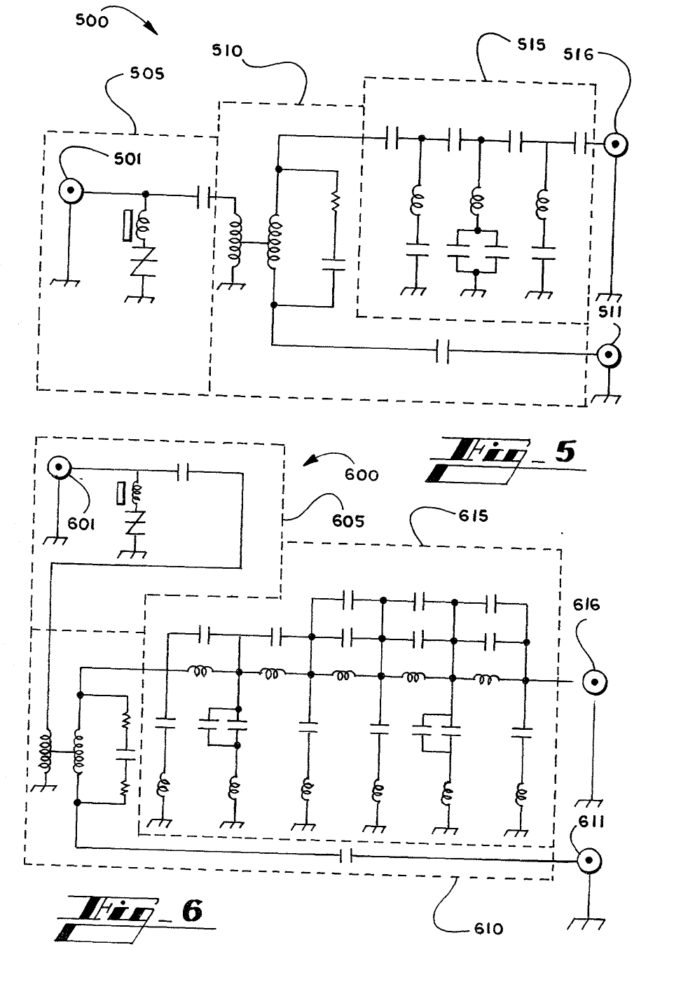

FIG. 3 illustrates a block diagram view of an alternate embodiment of a digital interface unit apparatus 300. This apparatus 300 includes a surge protection circuit 215 and a signal dividing circuit 210 as described above with respect to FIG. 2. There is no filter circuit in this embodiment. The signal dividing circuit 210 is therefore coupled to both the surge protection circuit 215 and to the outputs 130, 135. Some cable television systems do not require filters because they are said to be under good maintenance and have good signal control, therefore having low noise. In this embodiment, a filter circuit is not included.

FIG. 4 illustrates an embodiment of a digital interface system 400. The system 400 typically includes a digital interface unit apparatus such as apparatus 100 described above. The apparatus 100 is typically mounted to a surface by tabs 110. The input 125 and outputs 130, 135 are typically oriented so that they face downwards. A first coaxial cable 405 is connected to the input port 125. The coaxial cable 405 is typically a cable drop that includes the television and data signals. A second coaxial cable 410 is connected to the output port 130. The output port 130 typically carries the data signal as described above. The coaxial cable 410 typically enters the subscribers home and is connected to a data receiving device such as a cable modem. A third coaxial cable 415 is connected to the output port 135. The output port 135 typically carries the television signal as described above. The coaxial cable 415 typically enters the subscriber's home and is connected to a television signal receiving device such as a converter box or the television itself. The coaxial cables 405, 410, 415 are typically oriented in a “drip loop” configuration. The cables 405, 410, 415 come down then upward into the input 125 and outputs 130, 135. This drip loop configuration allows rain water to drip down and away from the digital interface apparatus 100, thereby preventing rust and corrosion to the input 125 and outputs 130, 135 as well as the housing 105, lid 106 and internal circuitry.

A ground wire 420 is connected to the grounding device 115 and secured by the screw 120. The wire 420 is connected to a grounding rod or electrode 425.

The remaining figures illustrate schematic diagrams of specific embodiments of digital interface unit apparatuses. It is understood that the specific embodiments illustrated do not limit the possibilities of further self-contained digital interface units contemplated in the descriptions discussed above. It is further understood by those skilled in the art that capacitance, inductance and resistance values can be chosen for the desired applications and to meet system requirements.

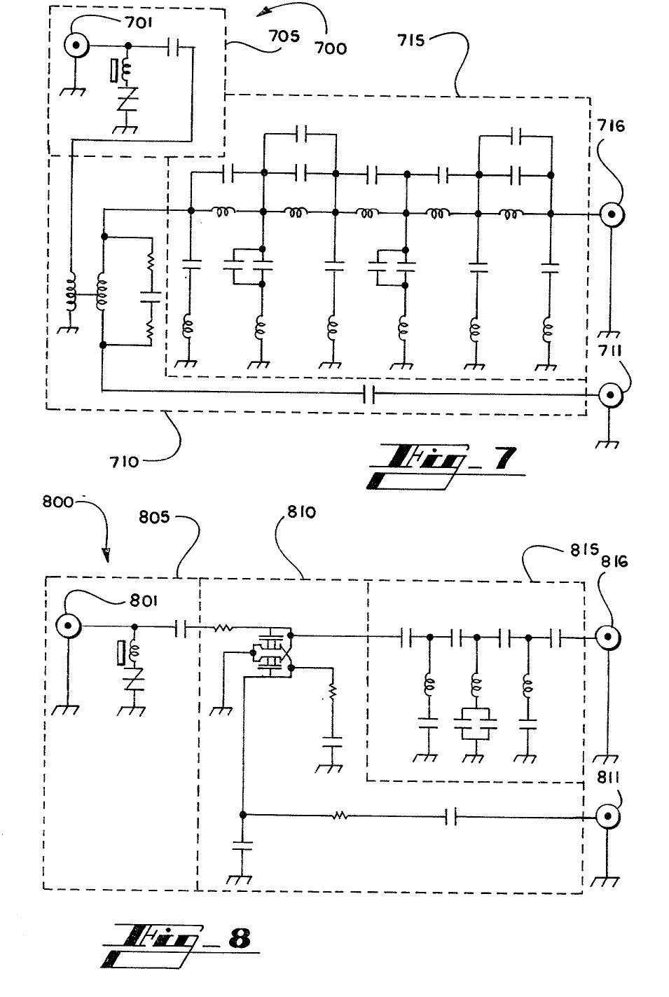

FIG. 5 illustrates a schematic diagram of an embodiment of a digital interface unit 500 having an input port 501 connected to a surge protection circuit 505 that is connected to a two-way splitter circuit 510 that is connected to an data signal output port 511 and to a high pass filter circuit 515 that is connected to a television signal output port 516.

FIG. 6 illustrates a schematic diagram of another embodiment of a digital interface unit having an input port 601 connected to a surge protection circuit 605 that is connected to a two-way splitter circuit 610 that is connected to an data signal output port 611 and to a 8-10 MHz window filter circuit 615 that is connected to a television signal output port 616.

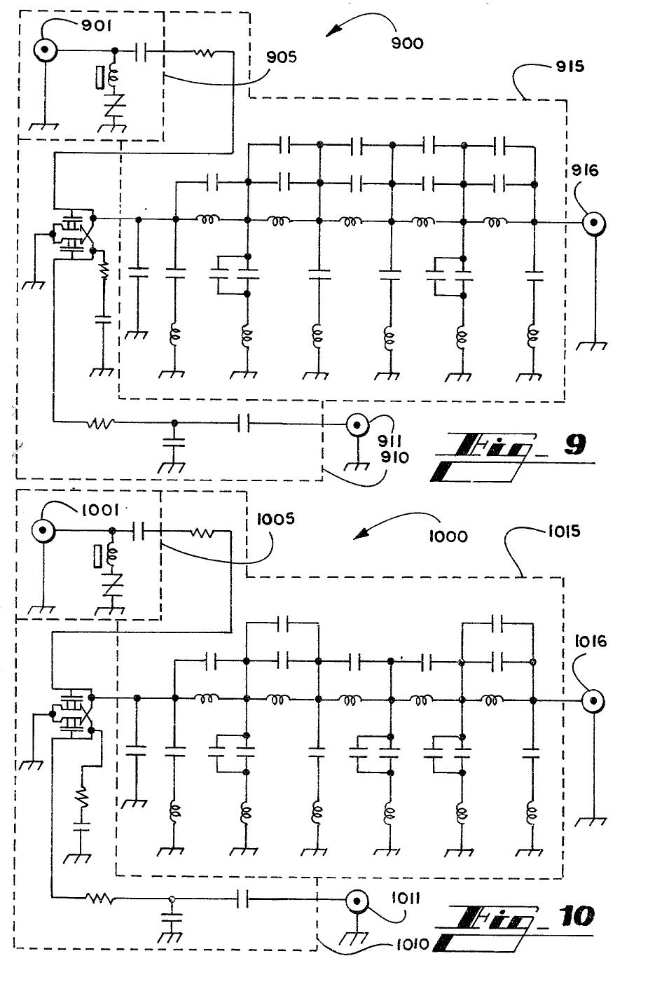

FIG. 7 illustrates a schematic diagram of another embodiment of a digital interface unit having an input port 701 connected to a surge protection circuit 705 that is connected to a two-way splitter circuit 710 that is connected to an data signal output port 711 and to a 5-13 MHz window filter circuit 715 that is connected to a television signal output port 716.

FIG. 8 illustrates a schematic diagram of another embodiment of a digital interface unit having an input port 801 connected to a surge protection circuit 805 that is connected to a 6 dB directional coupler circuit 810 that is connected to an data signal output port 811 and to a high pass filter circuit 815 that is connected to a television signal output port 816.

FIG. 9 illustrates a schematic diagram of another embodiment of a digital interface unit having an input port 901 connected to a surge protection circuit 905 that is connected to a 6 dB directional coupler circuit 910 that is connected to an data signal output port 911 and to a 8-10 MHz window filter circuit 915 that is connected to a television signal output port 916.

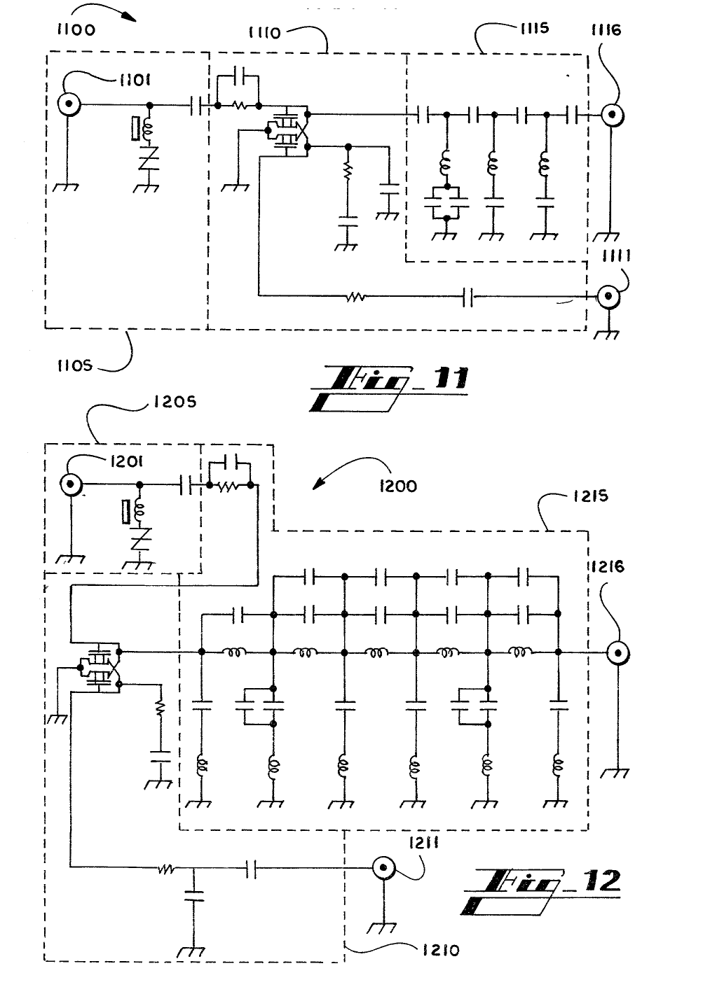

FIG. 10 illustrates a schematic diagram of another embodiment of a digital interface unit having an input port 1001 connected to a surge protection circuit 1005 that is connected to a 6 dB directional coupler circuit 1010 that is connected to an data signal output port 1011 and to a 5-13 MHz window filter circuit 1015 that is connected to a television signal output port 1016.

FIG. 11 illustrates a schematic diagram of another embodiment of a digital interface unit having an input port 1101 connected to a surge protection circuit 1105 that is connected to a 9 dB directional coupler circuit 1110 that is connected to an data signal output port 1111 and to a high pass filter circuit 1115 that is connected to a television signal output port 1116.

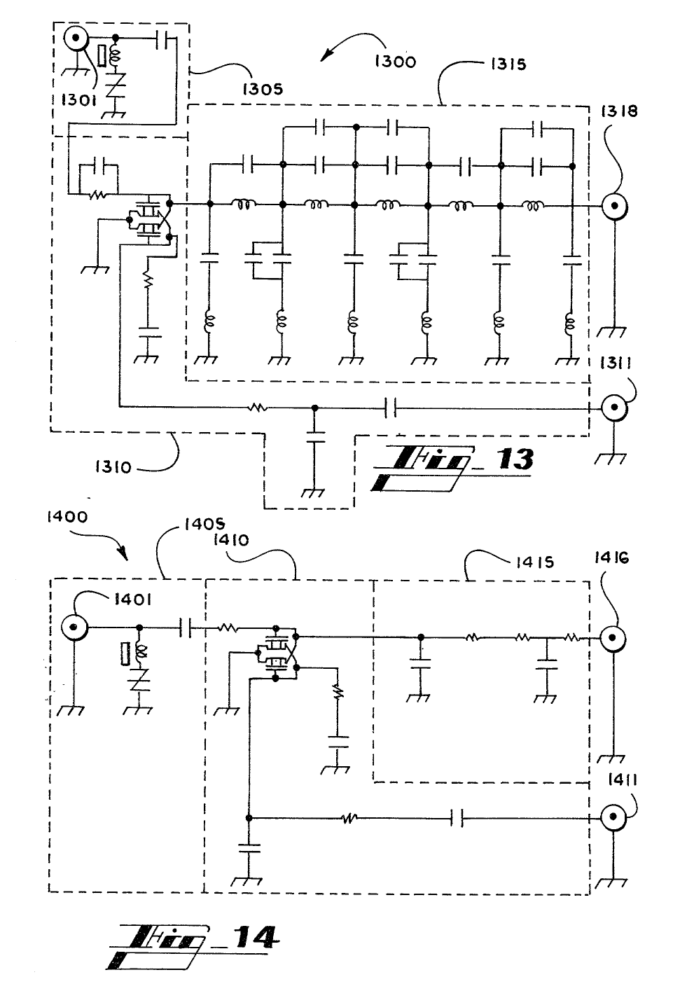

FIG. 12 illustrates a schematic diagram of another embodiment of a digital interface unit having an input port 1201 connected to a surge protection circuit 1205 that is connected to a 9 dB directional coupler circuit 1210 that is connected to an data signal output port 1211 and to an 8-10 MHz window filter circuit 1215 that is connected to a television signal output port 1216.

FIG. 13 illustrates a schematic diagram of another embodiment of a digital interface unit having an input port 1301 connected to a surge protection circuit 1305 that is connected to a 9 dB directional coupler circuit 1310 that is connected to an data signal output port 1311 and to a 5-13 MHz window filter circuit 1315 that is connected to a television signal output port 1316.

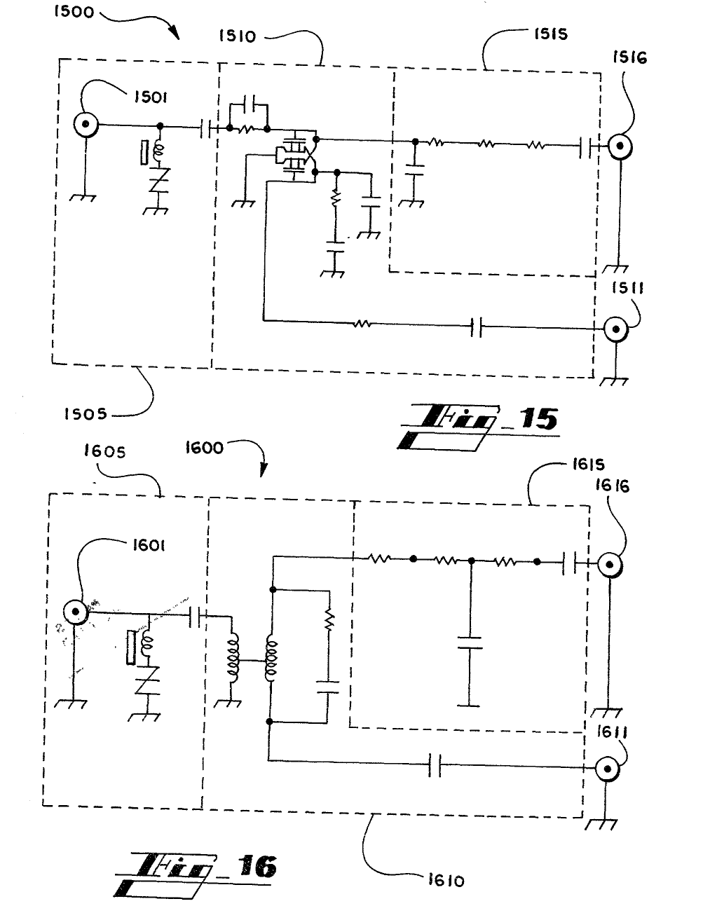

FIG. 14 illustrates a schematic diagram of another embodiment of a digital interface unit having an input port 1401 connected to a surge protection circuit 1405 that is connected to a 6 dB directional coupler circuit 1410 that is connected to an data signal output port 1411 and to a television signal output port 1416. No filter section is included. An additional circuitry section 1415 is added for signal continuity.

FIG. 15 illustrates a schematic diagram of another embodiment of a digital interface unit having an input port 1501 connected to a surge protection circuit 1505 that is connected to a 9 dB directional coupler circuit 1510 that is connected to an data signal output port 1511 and to a television signal output port 1516. No filter section is included. An additional circuitry section 1515 is added for signal continuity.

FIG. 16 illustrates a schematic diagram of another embodiment of a digital interface unit having an input port 1601 connected to a surge protection circuit 1605 that is connected to a two-way splitter circuit 1610 that is connected to an data signal output port 1611 and to a television signal output port 1616. No filter section is included. An additional circuitry section 1615 is added for signal continuity.

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A digital interface unit apparatus, comprising:
an input connected to a surge protection circuit;
a first output connected to a signal dividing circuit connected to the surge protection circuit; and
a second output connected to a filter circuit connected to the signal dividing circuit, wherein the surge protection, the signal dividing and the filter circuits are located within a single housing.

2. The apparatus as claimed in claim 1, wherein the signal dividing circuit is a two-way splitter.

3. The apparatus as claimed in claim 1, wherein the signal dividing circuit is a 6 dB directional coupler.

4. The apparatus as claimed in claim 1, wherein the signal dividing circuit is a 9 dB directional coupler.

5. The apparatus as claimed in claim 1, wherein the filter circuit is a high pass filter.

6. The apparatus as claimed in claim 1, wherein the filter circuit is a window filter.

7. The apparatus as claimed in claim 1, wherein the filter circuit is a 5-13 MHz window filter.

8. The apparatus as claimed in claim 1, wherein the filter circuit is a 8-10 MHz window filter.

9. The apparatus as claimed in claim 1 further comprising a grounding device connected to the housing.

10. The apparatus as claimed in claim 9, wherein the grounding device comprises a ground wire connection and a ground screw, both adapted to receive and connect a ground wire to the apparatus.

11. The apparatus as claimed in claim 1 further comprising voltage blocking capacitors electrically coupled to each of the input and the outputs.

12. The apparatus as claimed in claim 1, wherein the housing includes surface mounting tabs.

13. The apparatus as claimed in claim 1, wherein the input and the outputs are integral with the housing.

14. A self-contained cable television and digital signal interface apparatus, comprising:
a housing having three ports;
means for receiving a cable signal coupled to one of the ports;
means for dividing the signal located within the housing;
means for routing part of the divided signal to one of the ports; and
means for routing another part of the signal to one of the ports.

15. The apparatus as claimed in claim 14, wherein the means for dividing the signal is a splitter.

16. The apparatus as claimed in claim 14, wherein the means for dividing the signal is a directional coupler.

17. The apparatus as claimed in claim 14 further comprising means for filtering a part of the cable signal coupled to the means for dividing the signal and to one of the ports.

18. The apparatus as claimed in claim 14, wherein the cable signal comprises a television signal and a data signal.

19. A digital interface unit system, comprising:
a digital interface unit apparatus, comprising:
an input connected to a surge protection circuit,
a first output connected to a signal dividing circuit connected to the surge protection circuit, and
a second output connected to a filter circuit connected to the signal dividing circuit, wherein the apparatus is contained within a housing;
a ground connection connected to the housing;
a ground rod connected to ground and to the ground connection; and
a cable connected to each of the input and the outputs.

20. The system as claimed in claim 19 further comprising a cable modem connected to the first output.

21. The system as claimed in claim 19 further comprising a television system connected to the second output.
